(19) United States
(12) Patent Application Publication
(10) Pub. No.: US 2025/0205617 A1
(43) Pub. Date: Jun. 26, 2025

(54) SYSTEM AND METHOD FOR PNEUMATIC TO ELECTRIC CONVERSION FOR SEPARATOR

(71) Applicant: Vanzandt Controls, LLC, Odessa, TX (US)

(72) Inventors: Chad Gay, Farmington, NM (US); Don Barnes, Farmington, NM (US)

(73) Assignee: Vanzandt Controls, LLC, Odessa, TX (US)

(21) Appl. No.: 18/989,426

(22) Filed: Dec. 20, 2024

Related U.S. Application Data
(60) Provisional application No. 63/613,794, filed on Dec. 22, 2023.

(51) Int. Cl. B01D 17/12; B01D 17/02; B01D 19/00

(52) U.S. Cl. CPC B01D 17/12; B01D 17/0214; B01D 19/0063; B01D 19/0068

(57) ABSTRACT

The present disclosure provides systems and methods for converting a pneumatically controlled separator system, such as a liquid-gas separator system, to a separator system having electrically actuated controllers, pumps, and valves. The electrically actuated separator system of the present disclosure meets emissions standards and reduces (or eliminates) methane emissions that are harmful to the environment. The electrically actuated components of the system of the present disclosure may be powered with solar energy, which also reduces (or eliminates) carbon dioxide emissions.

### CROSS-REFERENCE TO RELATED APPLICATIONS

This application claims the benefit of U.S. Provisional Application No. 63/613,794, filed on Dec. 22, 2023, the entire disclosure of which is incorporated by reference herein.

### TECHNICAL FIELD

The present invention relates generally to oil and gas separators, and more specifically, to oil and gas separators having electric actuated controls that may be solar powered.

### BACKGROUND

Pneumatic devices are widely used in the oil and gas industry. The three main types of pneumatic devices used in the oil and gas industry are pneumatic controllers, which control conditions such as levels, temperatures, and pressure, pneumatic pumps/valves, which inject chemicals into wells and pipelines or circulate dehydrator fluids, and pneumatic valve actuators. These pneumatic devices are powered by gas pressure and are mainly used where electrical power is not available.

In the production segment, pneumatically controlled oil and gas separators are used to separate the components of the hydrocarbon streams produced at the wellhead. An oil and gas separator is a vertical or horizontal vessel that producers use to separate the elements of a fluid stream. The typical elements in the stream are oil, gas, water, and sand or sediment. As the gas, oil, and water enter the separator, they hit an inlet diverter and begin to separate. Because these elements have different specific gravities, the separation process will continue at a gradual pace. In particular, gas will rise to the top of the vessel, oil will settle in the middle, and water will drop to the bottom. The gas will eventually flow to a mist extractor at the top of the separator and be pulled out of the vessel and out to a sales line or for combustion. Natural gas-powered pneumatic controllers are regularly used to control and monitor gas and liquid flows and levels in these oil and gas separators. For instance, FIG. 1 depicts a traditional oil and gas separator having a pneumatic control system powered by natural gas. The pneumatic control system includes process control instruments and valves that are operated by natural gas. Indeed, as shown in FIG. 1, because the process control instruments and valves are operated by natural gas, the pneumatic control system requires the use of a gas scrubber to eliminate harmful particulates and liquid hydrocarbons from the natural gas before use.

While pneumatic devices are essential to the oil and gas industry, these devices, when powered using natural gas, can be one of the largest sources of methane emissions in petroleum and natural gas supply chains. Because these pneumatic devices are powered by natural gas, they emit methane and other pollution upon actuation. Methane emissions are harmful to the environment and can be more potent than carbon dioxide in trapping heat in the atmosphere. Indeed, methane is a much more potent warming agent than carbon dioxide, trapping 87 times more heat in the earth's atmosphere in the first twenty years after it is released (on a pound-for-pound basis).

The recently enacted Inflation Reduction Act (IRA) contains several new provisions related to methane emissions impacting oil and gas companies. Companies who already report emissions to the U.S. Environmental Protection Agency's (EPA) Greenhouse Gas Emissions Reporting Program under the Clean Air Act are likely to face stiff new charges starting in 2025, unless they reduce their emissions below the 25,000 metric tons of carbon dioxide equivalent threshold. Central to the new “Methane Emissions Reduction Program” in the IRA is the methane emissions charge, which the IRA authorizes the EPA to collect from certain entities in the oil and natural gas sector starting in 2024. The methane emissions charge will start at $900 per metric ton of methane emitted in 2024 and increase to $1,200 in 2025 and $1,500 in 2026. As such, there is an ever-increasing focus by oil and gas producers to reduce methane emissions through the development of new technologies and processes.

Methods of reducing methane emissions from pneumatic devices range from preventing emissions, to reducing emissions, to repairing those devices with emissions that are higher than expected. For example, to reduce methane and carbon emissions, some companies have converted their natural gas-powered pneumatic control systems to compressed instrument air systems. Instrument air systems substitute compressed air for the pressurized natural gas, eliminating methane emissions and providing additional safety benefits. However, instrument air systems are not always easily accessible, especially in remote locations. Similarly, some well sites have installed electric valves. This eliminates the requirement for compressed air, but this option has significant limitations that impact long term maintenance and reliability. For instance, when the well flow is significant, the electric valve will constantly cycle open and closed, wearing it out quickly and requiring valve replacements. Valve replacements cost money and result in lost production. This option also requires significant electrical power, which can be a problem at remote sites.

Accordingly, there remains a need in the art for converting a pneumatically controlled oil/gas separator system to an electric separator system that can operate efficiently while also reducing or eliminating methane and/or carbon emissions.

### SUMMARY

The problems expounded above, as well as others, are addressed by the following inventions, although it is to be understood that not every embodiment of the inventions described herein will address each of the problems described above.

In some embodiments, a separator is provided, the separator including a programmable controller, a level controller for maintaining a level of a process fluid in the separator, the level controller operatively connected to the programmable controller and the level controller including an electric switch for sending a signal to the programmable controller when the level of the process fluid in the separator is at a predetermined high set point, a valve operatively connected to the programmable controller and the level controller, wherein the valve is an electrically actuated valve having an open position that allows the process fluid to flow through the valve and a closed position that prevents the process fluid from flowing through the valve, and wherein the programmable controller is configured to receive the signal from the level controller when the level of the process fluid in the separator is at the predetermined high set point and, in response, communicate the signal to the electrically actuated valve such that the valve moves to the open position.

In one embodiment, the programmable controller is a programmable logic controller. In another embodiment, the electrically actuated valve includes a valve body size of about 1 inch to about 2 inches. In still another embodiment, the separator may further include a device for capturing and storing solar energy. In yet another embodiment, the programmable controller includes a relay circuit, wherein the relay circuit is operatively connected to the level controller and the electrically actuated valve. In another embodiment, the process fluid may be oil, gas, or water. In yet another embodiment, the separator may further include a second valve operatively connected to the programmable controller and to a second level controller, the second level controller including an electric switch for sending a signal to the programmable controller when the level of a second process fluid in the separator is at a predetermined high set point. In still another embodiment, the separator may include a sales valve configured for controlling the flow of gas out to a sales line, wherein the sales valve is an electrically actuated valve. In some embodiments, the level controller is intrinsically safe and/or explosion proof.

In further embodiments, a separator is provided, the separator including a programmable controller, a level controller for maintaining a level of a process fluid in the separator, the level controller operatively connected to the programmable controller and the level controller including a fiber optic sensor system for sending an electrical signal to the programmable controller when the level of the process fluid in the separator is at a predetermined high set point, wherein the fiber optic sensor system includes an optical fiber configured to transmit and receive an optical signal between an emitter and a sensor positioned on the level controller, wherein the sensor is configured to reflect at least a portion of the optical signal through the optical fiber when the level of the process fluid reaches the predetermined high set point, an amplifier in optical communication with the optical fiber, wherein the amplifier is configured to amplify the reflected optical signal, and a receiver operatively connected to the amplifier, wherein the receiver is configured to convert the amplified optical signal into an electrical signal, a valve operatively connected to the programmable controller and the level controller, wherein the valve is an electrically actuated valve having an open position that allows the process fluid to flow through the valve and a closed position that prevents the process fluid from flowing through the valve, and wherein the programmable controller is configured to receive the electrical signal from the receiver when the level of the process fluid in the separator is at the predetermined high set point and, in response, communicate the signal to the electrically actuated valve such that the valve moves to the open position.

In one embodiment, the emitter includes a laser diode or a light-emitting diode (LED). In another embodiment, the sensor is in direct contact with the level controller. In still another embodiment, the programmable controller is a programmable logic controller. In another embodiment, the programmable controller is further configured to receive an electrical signal from the receiver when the level of the process fluid in the separator is below the predetermined high set point and, in response, communicate the signal to the electrically actuated valve such that the valve moves to the closed position. In still another embodiment, the level controller is intrinsically safe and explosion proof.

### BRIEF DESCRIPTION OF THE DRAWINGS

Further features and advantages can be ascertained from the following detailed description that is provided in connection with the drawings described below:

FIG. 1 is a schematic illustration of a traditional oil and gas separator having a pneumatic control system powered by natural gas.

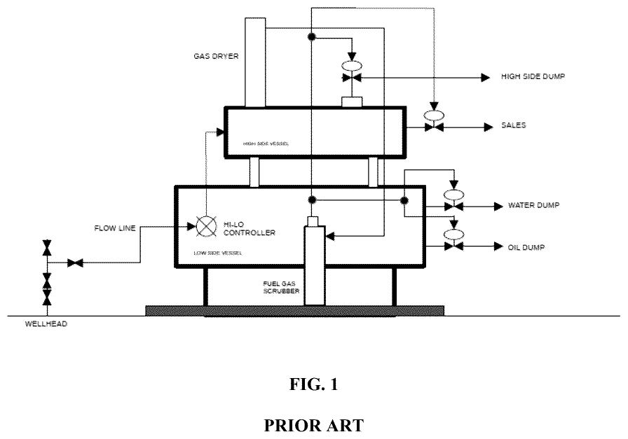

FIG. 2 is a schematic illustration of an electrically actuated separator system in accordance with one embodiment of the present disclosure.

FIG. 3 is a schematic diagram of a computing device for use with the present systems and methods according to one embodiment of the present disclosure.

FIG. 4 is a schematic illustration of an interface board for use in a controller of the electrically actuated separator system in accordance with one embodiment of the present disclosure.

FIG. 5 is a perspective view of an electric level controller according to one embodiment of the present disclosure.

FIG. 6 is a schematic diagram of a fiber optic sensor system for use with a level controller according to one embodiment of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Spatially relative terms, such as “above,” “under,” “below,” “lower,” “over,” “upper,” and the like, may be used herein for ease of description to describe one element or feature's relationship to another when the apparatus is right side up as shown in the accompanying drawings.

It is to be understood that any given element of the disclosed embodiments of the invention may be embodied in a single structure, a single step, a single substance, or the like. Similarly, a given element of the disclosed embodiment may be embodied in multiple structures, steps, substances, or the like.

The present disclosure provides a system for converting a pneumatically controlled separator system, such as a liquid-gas separator system, to a separator system having electrically actuated components. That is, the components of the separator of the present disclosure, for example, controllers, pumps, valves, and valve actuators, are powered by electricity. The electrically actuated separator system of the present disclosure meets emissions standards and reduces (or eliminates) methane emissions that are harmful to the environment. The electrically actuated system of the present disclosure also provides for higher flow and production rates since the system does not operate with natural gas and thus does not run the risk of leaking. In some embodiments, the electrically actuated components of the system of the present disclosure are powered with solar energy, which also reduces (or eliminates) carbon dioxide emissions.

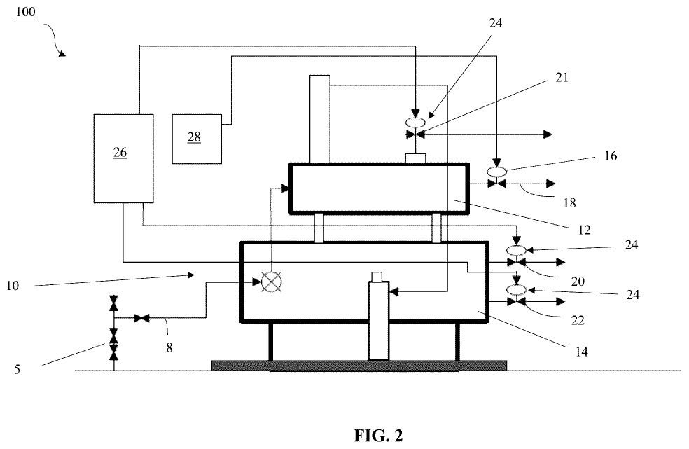

Referring to FIG. 2, a schematic diagram of an electrically actuated separator system 100 according to one embodiment of the present disclosure is illustrated. The separator system 100 includes a separator 10 which is an apparatus for separating oil, water, gas, and solid particles from a hydrocarbon-containing fluid produced from an oil and/or gas production facility. The separator 10 as described herein is intended to separate three phases from hydrocarbon-containing fluid: oil, gas, and water. However, the present disclosure may also be utilized with two-phase separators that handle gas and liquid. In addition, the separator 10 as shown in FIG. 2 is a double tube horizontal separator 10 with a high side vessel 12 and a low side vessel 14. Though, as will be appreciated by those skilled in the art, the present disclosure may be utilized with other types of separators including, but not limited to, vertical separators, single tube horizontal separators, and spherical separators.

The separator 10 is operatively connected to a wellhead 5 by flow line 8. The flow line 8 supplies the resource, for example, an emulsion of oil, water, and gas, from the wellhead 5 to the separator 10. As the gas, oil, and water enter the separator 10, the components begin to separate. Because the components have different specific gravities, the gas component will rise to the high side vessel 12, the oil will settle in the middle of the low side vessel 14, and the water will drop to the bottom of the low side vessel 14. The gas will flow to the top of the separator 10 and be pulled out of the high side vessel 12 through a sales valve 16. The sales valve 16 controls the flow of the gas out to a sales line 18. A “sales line,” as used herein, refers to a pipeline that transports marketable gas products such as natural gas, natural gas liquids or oil to the marketplace for the purpose of being sold.

The liquid components, such as the oil and water, leave the separator 10 through various dump valves that are operated automatically by receiving a signal generated from a control system, as will be discussed in more detail below. As illustrated in FIG. 2, the water leaves the separator 10 through a first dump valve 20 and the oil leaves the separator through a second dump valve 22. Both the first and second dump valves 20 and 22 are operatively connected to the low side vessel 14. The separator 10 may also include a third dump valve 21 to vent excess gas pressure. The third dump valve 21 may be operatively connected to the high side vessel 12.

The present disclosure contemplates the use of electrically actuated valves, such as an electrically actuated sales valve 16 and electrically actuated first, second, and third dump valves 20-22. In this embodiment, the valves of the separator system 100, such as the sales valve 16 and the first, second, and third dump valves 20-22, are powered with electricity (rather than natural gas). That is, the sales valve 16 and the first, second, and third dump valves 20-22 are electrical actuated valves that use an electric motor to operate the valve and control the flow of media. For example, in one embodiment, the sales valve 16 and the first, second, and third dump valves 20-22 may be electric actuated ball valves (also known as motorized ball valves or rotary ball valves). A “ball valve,” as used herein refers to a quarter-turn on/off valve that controls the flow of liquid or gas media via a pivoting ball. The ball valves have an open position that allows the fluid to flow through the ball valve and a closed position that prevents fluid from flowing through the ball valve. Electric actuated ball valves use an electric motor to operate a ball valve and control the flow of media. In one embodiment, the sales valve 16 and the first, second, and third dump valves 20-22 use voltage to power the valve on and off. In one embodiment, the electric actuated valves 20-22 may have a 12-volt motor. In another embodiment, the electric actuated valves 20-22 may have a 24-volt motor.

The valve dimensions may vary depending on the desired flow rate of the valve, port size, and valve construction. In one embodiment, the valves of the present disclosure may have a valve body size of about 0.5 inches to about 3 inches. In another embodiment, the valves of the present disclosure may have a valve body size of about 1 inch to about 2 inches. For instance, the first, second, and third dump valves 20-22 may utilize valves having a valve body size of about 1 inch. In another embodiment, the sales valve 16 may utilize a valve having a valve body size of about 2 inches. The valves utilized with the present disclosure allow for larger orifices on the dump valves and the sales valve (compared to pneumatic valves), which, in turn, allows for higher flow rates and production rates.

The separator 10 also includes a level controller 24 that may be used to control the level of oil, water, or other liquids in the separator 10. In some embodiments, the level controller 24 is electrically actuated. The level controller 24 detects liquid level, such as the levels of the oil and water in the separator 10, (and gas levels) and sends the measurement reading as an electric signal to a control system. The level controller 24 may include a displacement-type sensor placed inside the vessel 14. When the liquid level in the low side vessel 14 is such that it engages the displacement-type sensor, the displacement-type sensor will move as the level of the liquid changes. The changes in the liquid level are transmitted to a control system which signals the first and second dump valves 20 and 22 to either open or close in response to the changing liquid level in the vessel which will either allow flow or stop flow from the vessel. In some embodiments, changes in gas pressure are also transmitted to the control system which signals the third dump valve 21 to either open or close in response to the changing gas pressure. In further embodiments, each dump valve described herein may be controlled by a separate level controller. That is, each of the first, second, and third dump valves 20-22 may be controlled by individual level controllers. In other words, the electrically actuated separator system 100 may include at least three different level controllers 24.

The components of the separator 10, for instance, the electrically actuated valves and level controllers, are operatively connected to one or more controllers. In one embodiment, the electrically actuated first, second, and third dump valves 20-22 and the electrically actuated level controllers 24 are operatively connected to a first controller 26. As will be described in more detail below, the first controller 26 processes inputs (for example, level measurements) from the level controllers 24 and provides outputs to the first, second, and third dump valves 20-22. The first controller 26 advantageously allows for control of the electrically actuated dump components of the separator system 100 without having to replace the original pneumatic controller. In another embodiment, the electrically actuated sales valve 16 is operatively connected to a second controller 28. The second controller 28 is configured to process an input, such as a level measurement, and provide an output to the sales valve 16 to allow or stop the flow of the gas out to the sales line 18.

The first controller 26 receives and interprets system information from the electrically actuated dump components of the separator system 100, such as the electrically actuated first, second, and third dump valves 20-22 and the electrically actuated level controllers 24. The second controller 28 receives and interprets system information from the electrically actuated sales valve 16. The first and second controllers 26 and 28 may be any controller that conforms to IEC61131.5 programming language and includes a Modbus interface. For instance, the first and second controllers 26 and 28 may be any programmable system including systems and microcontrollers, reduced instruction set circuits (RISC), application specific integrated circuits (ASIC), programmable logic circuits, and any other circuit or processor capable of executing the functions described herein. In some embodiments, the first and second controllers 26 and 28 are programmable logic controllers (PLCs). A PLC is a specialized computer control system configured to execute software which continuously gathers data on the state of input devices to control the state of output devices. A PLC typically includes a processor (which may include volatile memory), volatile memory including an application program, and one or more input/output (I/O) ports for connecting to other devices in the automation system. The PLC can be paired with Human Machine Interface (HMI) or Supervisory, Control and Data Acquisition (SCADA) systems.

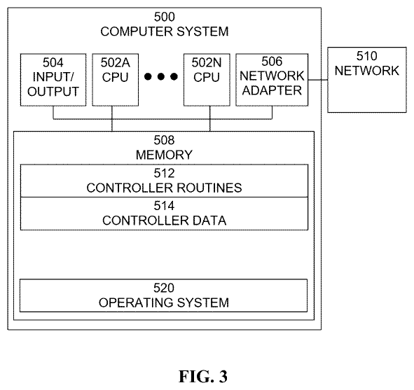

In some embodiments of the present disclosure, the first and second controllers 26 and 28 include a computing device 500, as shown in FIG. 3. In another embodiment, the first and second controllers 26 and 28 are communicatively coupled to the computing device 500. The computing device 500 may be implemented using one or more programmed general-purpose computer systems, such as embedded processors, systems on a chip, personal computers, workstations, server systems, and minicomputers or mainframe computers, or in distributed, networked computing environments. The computing device 500 may include one or more processors (CPUs) 502A-502N, input/output circuitry 504, network adapter 506, and memory 508. CPUs 502A-502N execute program instructions to carry out the functions of the present systems and methods. Typically, CPUs 502A-502N are one or more microprocessors, such as an INTEL CORE® processor.

Input/output circuitry 504 provides the capability to input data to, or output data from, the computing device 500. For example, input/output circuitry 504 may include input devices, such as a graphical user interface, keyboards, mice, touchpads, trackballs, scanners, and analog to digital converters; output devices, such as display screens, video adapters, monitors, and printers; and input/output devices, such as modems.

Network adapter 506 interfaces the computing device 500 with a network 510. Network 510 may be any public or proprietary data network, such as LAN and/or WAN (for example, the Internet). Memory 508 stores program instructions that are executed by, and data that are used and processed by, CPU 502 to perform the functions of the computing device 500. Memory 508 may include, for example, electronic memory devices, such as random-access memory (RAM), read-only memory (ROM), programmable read-only memory (PROM), electrically erasable programmable read-only memory (EEPROM), and flash memory, and electro-mechanical memory, which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, or Serial Advanced Technology Attachment (SATA), or a variation or enhancement thereof, or a fiber channel-arbitrated loop (FC-AL) interface.

Memory 508 may include controller routines 512, controller data 514, and operating system 520. Controller routines 512 may include software routines to perform processing to implement one or more controllers. Controller data 514 may include data needed by controller routines 512 to perform processing. For example, controller routines 512 may include software for analyzing incoming data related to level measurements within the separator 10 and operation of the various valves operatively connected to the separator 10.

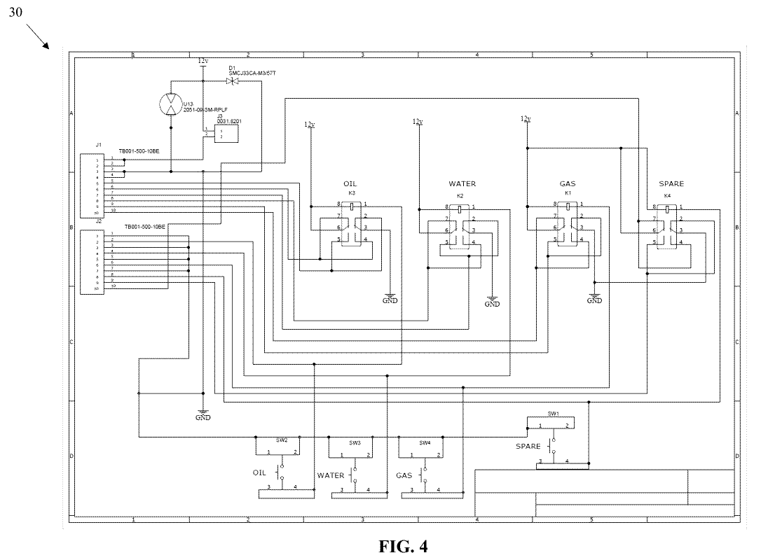

FIG. 4 is a schematic diagram of wiring for an interface board or a printed circuit board (PCB) 30 for use with the first controller 26 according to one embodiment of the present disclosure. The PCB 30 is designed to control the electrically actuated dump valve components in the separator system 100. In some embodiments, each of the electrically actuated first, second, and third dump valves 20-22 and the electrically actuated level controllers 24 are operatively connected to the PCB 30 via the wiring schematic provided in FIG. 4. Advantageously, the PCB 30 with the exemplified wiring diagram can be installed on any type of controller, including a pneumatic controller, to control electrically actuated components. In this aspect, a user does not need to replace an existing pneumatic controller. Rather, the PCB 30 can be installed on the pneumatic controller and be used to control the electrically actuated valve components of the separator system.

The diagram shown in FIG. 4 provides exemplary wiring for connecting the electrically actuated first, second, and third dump valves 20-22 and the electrically actuated level controllers 24 to the first controller 26. The wiring diagram depicts a four-relay board for switching the first dump valve 20, the second dump valve 22, and third dump valve 21 off and on based on one or more electrical signals received from the level controllers 24. As shown in FIG. 4, each relay has a switch adapted to close while actuated. For example, the PCB 30 in the first controller 26 can receive a signal from the level controller 24 and turn the switch for the first dump valve 20 on and off to either open or close the valve in response to the changing water level in the separator 10. Similarly, for instance, the PCB 30 in the first controller 26 can receive a signal from the level controller 24 and turn the switch for the second dump valve 22 on and off to either open or close the valve in response to the changing oil level in the separator 10. In still another embodiment, the PCB 30 in the first controller 26 can receive a signal from the level controller 24 and turn the switch for the third dump valve 21 on and off to either open or close the valve in response to the changing gas level in the separator 10. In further embodiments, the PCB 30 in the first controller 26 may include a spare switch in the event one of the aforementioned switches malfunctions.

The relays shown in FIG. 4 are responsive to input signals originating from their respective level controllers 24. Operating autonomously, the default or “at rest” position of the level controllers mandates that all dump controller switches assume the normally open (NO) position. Additionally, all actuators are pre-set with a specific voltage polarity to ensure the valves remain in the closed position absent a signal from the respective level controller. In some embodiments, for energy conservation in solar-powered installations, all relays on the board default to the unenergized position.

In the event the oil level surpasses the designated set point within the low side vessel 14, the level controller 24 for the oil dump issues a close signal via J2, activating oil relay K3. The energized coil in K3 alternates the voltage polarity from the relay contacts to the oil actuator. As the oil actuator opens, pressure propels the oil into a collection tank, thereby reducing the oil level below the set point. Subsequently, the level controller 24 for the oil dump sends an open contact signal to the relay board, de-energizing oil relay K3 and resetting it to the default contact point. This sequence alternates the voltage polarity to the oil actuator, prompting closure of the second dump valve 22. Once closed, the low side vessel 14 is precluded from releasing additional oil until the set point is exceeded anew.

Considering water as a byproduct of oil extraction, it accumulates in a dedicated section of the low side vessel 14. The water level is subject to monitoring by the level controller 24 for the water dump. In the event the water dump's set point be exceeded, it dispatches a closed contact signal via J2 on the relay board to relay K1, thereby energizing the relay. Energized relay K1 alternates the control voltage polarity to the water actuator, signaling a demand to open the first dump valve 20. The first dump valve 20 remains open until the fluid level descends below the water dump's (level controller's) set point. Upon reaching this threshold, the level controller 24 issues an open contact condition signal to the relay board, de-energizing relay K1. As relay K1 reverts to its default position, it alternates the voltage polarity back to the water actuator, effecting closure of the first dump valve 20. Once closed, further flow of water from the low side vessel 14 is precluded.

Typically, the separator 10 operates under pressure. If the pressure within the vessel 12 exceeds a predetermined set point, the third dump valve 21 is employed to vent excess gas pressure. Gas pressure is monitored by the level controller 24 for the gas dump. Upon surpassing the gas dump's set point, it transmits a closed contact signal via J2 on the relay board to relay K2, energizing the relay. Energized relay K2 alternates the control voltage polarity to the gas actuator, signaling a request to open the third dump valve 21. As the gas actuator opens, gas flows out of the vessel 12 into a collection tank. The third dump valve 21 remains open until the gas pressure drops below the gas dump's set point. Upon reaching this point, the level controller 24 for the gas dump sends an open contact condition signal to the relay board, de-energizing relay K2. As relay K2 returns to its default position, it alternates the voltage polarity back to the gas actuator, resulting in the closure of the third dump valve 21. Once closed, the gas pressure in the vessel 12 is contained, preventing further gas flow.

The primary function of SW2-SW4 is geared towards troubleshooting and serves as a testing method. These switches emulate the behavior of level controllers and function autonomously, independent of the actual level controllers. Relay K4 is a spare redundant relay that can be used for applications involving additional actuators or troubleshooting purposes.

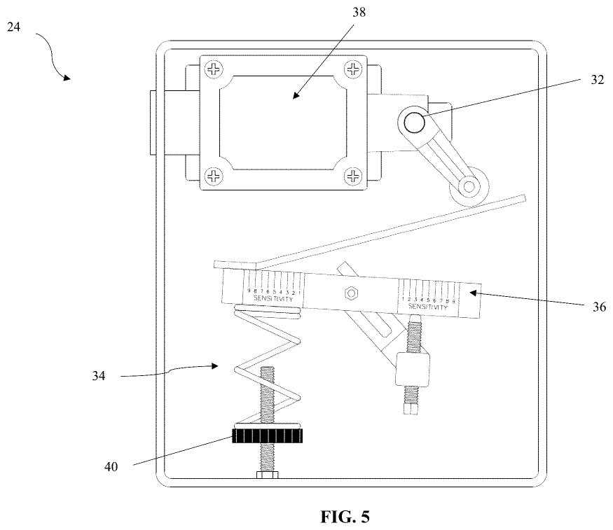

FIG. 5 shows the electrically actuated level controller 24 according to one embodiment of the present disclosure. The electrically actuated level controller 24 shown in FIG. 5 can be wired to the first controller 26 via the wiring diagram shown in FIG. 4. The electrically actuated level controller 24 of the present disclosure can detect the interface of the liquids (such as the oil and water) in the separator 10 and transmit an electric signal to the first controller 26 to tell the electrically actuated dump valves 20-22 to open once the respective process fluids have reached a high-level setpoint.

The level controller 24 detects the interface of two liquids by using a displacement-type sensor in the process fluid that monitors the liquid level. As shown in FIG. 5, the level controller 24 includes a spring 34 and a torque bar 36 balanced above the spring 34. The tension of the spring 34 can be adjusted via an adjusting knob 40. This allows for the set points to be adjusted to the desired level. By increasing tension on the spring 34, a lower level is sensed. By decreasing tension on the spring 34, a higher level is required to produce the same force as before. For example, to lower the level or set point, the adjusting knob 40 under the spring 34 can be turned clockwise to increase compression on the spring 34. To raise the level or set point, the adjusting knob 40 under the spring 34 can be turned counterclockwise to decrease compression on the spring 34. The level controller 24 may also include a sensitivity fulcrum with a screw attached thereto (not shown) for adjusting the sensitivity.

As illustrated in FIG. 5, an electric switch 32 is positioned above the torque bar 36. The electric switch 32 is operatively connected to a circuit board 38 and communicates with the first controller 26. As process fluid rises around the displacement-type sensor, the tension of the spring 34 increases and the torque bar 36 moves upward until it engages with the electric switch 32. When the torque bar 36 engages with the electric switch 32, the electric switch 32 is triggered. The electric switch 32 is triggered when the process fluid has reached the high-level setpoint. At this point, the electric switch 32 sends a signal to the first controller 26, as explained above, to start the motors on the first dump valve 20, the second dump valve 22, and/or the third dump valve 21 which allows the valves to open. When the displacement-type sensor senses the low-level setpoint, the signal stops thus allowing the first dump valve 20, the second dump valve 22, and/or the third dump valve 21 to close.

In further embodiments, the level controller 24 of the present disclosure may include a fiber optic sensor. The use of a fiber optic sensor provides accurate and reliable monitoring of fluid levels while mitigating the risks associated with traditional electrically-controlled systems in explosive atmospheres. Indeed, when compared to the use of electric switches, the fiber optic sensors described herein provide improved signal-to-noise ratio for accurate liquid level monitoring, offer a more compact and robust design suitable for installation in hazardous environments, and enhance the safety profile of the liquid level controllers by reducing the risk of explosion from electrical sparks. The fiber optic sensors disclosed herein can be integrated into the level controllers of the present disclosure or into pre-existing liquid level controllers and electric valves.

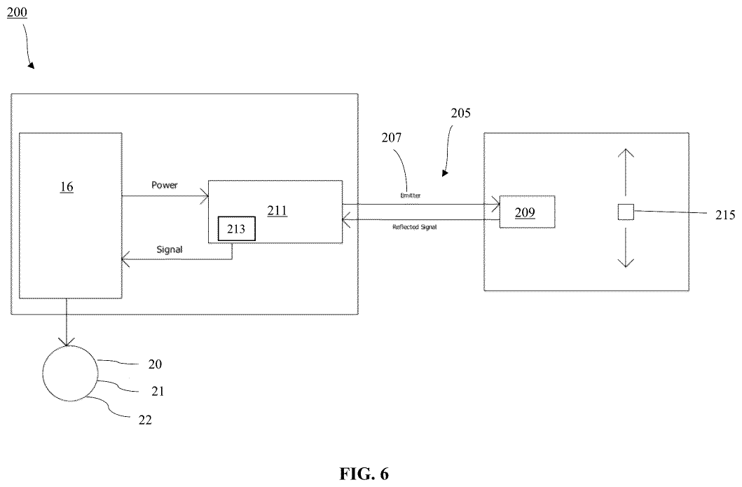

FIG. 6 is a schematic diagram of a fiber optic sensor system 200 for integration with the level controller 24. The fiber optic sensor system 200 shown in FIG. 6 can be wired to and communicate with the first controller 26. Like the electrically actuated level controller described above, the level controller 24 with the fiber optic sensor system 200 can detect the interface of the process fluids (such as the oil and water) in the separator 10 and transmit an electric signal to the first controller 26 to tell the electrically actuated dump valves 20-22 to open once the respective process fluids have reached a high-level setpoint.

The fiber optic sensor system 200 includes an emitter 207 in optical communication with a sensor 209 on the level controller 24. The emitter 207 is operatively connected to the sensor 209 by a fiber optic cable 205. The fiber optic cable 205 is configured to transmit and receive an optical signal between the emitter 207 and the sensor 209. The emitter 207 emits optical signals, such as light, through the fiber optic cable 205 to the sensor 209. The sensor 209 is configured to reflect at least a portion of the optical signal back through the fiber optic cable 205 when the level of the object 215, for example, the process fluid, reaches a predetermined high set point.

The fiber optic cable 205 may be any type of fiber optic cable known in the art that is able to minimize signal loss and is flexible and durable enough to withstand the rigors of oil field environments. In one embodiment, the fiber optic cable 205 is a dual core fiber that includes both the emitting and receiving fibers, which are aligned to optimize the reflective sensing process.

The emitter 207 is a light source for the system 200 (e.g., it generates the light to be carried through the fiber optic cable). In one embodiment, the emitter 207 may be a laser diode, for example, a FP (Farby Parot) laser diode, a distributed feedback (DFB) type, or a vertical cavity surface-emitting laser (VCSEL) type. In another embodiment, the emitter 207 may be a light-emitting diode (LED). The sensor 209 may be any compact assembly that is capable of integrating both of the emitting and receiving fibers of the fiber optic cable 205 into a single unit. The alignment of the emitting and receiving fibers allows for efficient light transmission and reception, enhancing the overall performance of the sensor system 200. In one embodiment, the sensor 209 is in direct contact with the level controller 24 to provide a high-sensitivity surface for capturing reflected light.

The fiber optic sensor system 200 also includes a fiber optic amplifier 211 operatively connected to, for instance, in optical communication with, the fiber optic cable 205. The fiber optic amplifier 211 enhances the quality of the received signal by amplifying the light signal within the fiber optic cable 205 to improve the signal-to-noise ratio. This ensures that the received signal is strong and clear, even in the presence of interference or attenuation. In some embodiments, the fiber optic amplifier 211 is configured to amplify the reflected light to a level suitable for accurate detection. This allows for accurate detection under various light conditions and in the presence of interfering particles, such as dust. A receiver 213 is configured to receive the amplified optical signal from the fiber optic amplifier 211 and convert the amplified optical signal into an electrical signal.

In some embodiments, the fiber optic amplifier 211 is a solid-state amplifier. A solid-state amplifier uses a solid-state gain medium, such as a crystal or glass, to amplify the light signal. The gain medium is excited by a pump source, for example, a flash lamp or laser diode. As the pump energy is absorbed by the gain medium, it produces a population inversion, which allows the light signal to be amplified. Examples of solid-state amplifiers suitable for use with the disclosed systems include, but are not limited to, neodymium-doped yttrium aluminum garnet (Nd:YAG) and titanium-doped sapphire (Ti:sapphire) amplifiers. In another embodiment, the fiber optic amplifier 211 may be a fiber amplifier. A fiber amplifier uses an optical fiber as the gain medium to amplify the light signal. A pump laser is injected into the fiber, which produces a population inversion and amplifies the signal. Examples of fiber amplifiers include, but are not limited to, erbium-doped fiber amplifiers (EDFAs) and Raman amplifiers.

As shown in FIG. 6, the first controller 26 is operatively connected to and communicates with the receiver 213 and the fiber optic amplifier 211. In one embodiment, the first controller 26 is configured to provide power to the fiber optic amplifier 211 and process the electrical signals obtained from the receiver 213. As discussed above, the first controller 26 may be any controller that conforms to IEC61131.5 programming language and includes a Modbus interface. For example, the first controller 26 may be a PLC. The first controller 26 includes a microprocessor that interprets the received signals and sends appropriate commands to the electrically actuated dump valves 20-22. For example, the first controller 26 can process the received signal to control the opening and closing of the electrically actuated dump valves 20-22. While the controller for the fiber optic sensor system 200 has been exemplified herein as the first controller 26, those skilled in the art will appreciate that the fiber optic sensor system 200 may be integrated with any type of controller that is equipped with communication protocols to interface with various types of liquid level controllers and control systems.

In operation, the emitter 207 generates an optical (light) signal that is transmitted through the fiber optic cable 205 to the sensor 209. The sensor 209 emits the light toward the object of interest 215, for example, the process fluid in the separator. When the sensed object moves in front of the emitted light, a portion of the light is then reflected back into the receiving fiber of the fiber optic cable 205. The reflected signal travels through the fiber optic cable 205 to the fiber optic amplifier 211, which amplifies the light intensity to improve the signal-to-noise ratio. The amplified signal is then converted into an electrical signal by the receiver 213 and sent to the first controller 26 for analysis. Based on the processed data, the first controller 26 determines the appropriate action for the electrically actuated dump valves 20-22. That is, the first controller 26 determines whether the electrically actuated dump valves 20-22 should be opened or closed to regulate the fluid level.

The fiber optic sensor system 200 described herein allows for precise and reliable liquid level control in the presence of explosive gases, dust, and varying light conditions—all of which are conditions that occur in oil field applications. By integrating the fiber optic amplifier 211 into the system's design, the system 200 also achieves superior signal detection and communication with electrically actuated dump valves 20-22. The system's ability to enhance the reliability of liquid level monitoring while maintaining a high degree of accuracy under challenging conditions is a substantial contribution to the field.

In one embodiment, the level controller 24 is intrinsically safe. As used herein, “intrinsically safe” means that the piece of equipment itself cannot cause an explosion. For example, the level controller 24 may include intrinsic barriers that limit the energy transfer between circuits. Intrinsic barriers are certified to make the device incapable of producing a spark that can ignite hazardous environments. In another embodiment, the level controller 24 is explosion proof. The term, “explosion proof,” as used herein means that if an explosion occurred, the device would be protected by an explosion-proof enclosure that helps contain explosions and prevent them from spreading. Explosion proof equipment is certified for use in hazardous areas. In some embodiments, the level controller 24 may be enclosed with a material, such as stainless steel or cast aluminum, that is strong enough to both contain an explosion and survive an explosion. Explosion proof equipment generally operates at normal energy levels with its construction that prevents temperatures from reaching hazardous temperatures (according to the respective group rating) that could cause an explosion.

The level controller 24 of the present disclosure can be installed on any type of pneumatic level controller to convert the device to electric. In this embodiment, the pneumatic level controller is removed and replaced with the level controller 24. In this aspect, the pneumatic supply lines attached to the pneumatic level controller on the backside of the enclosure as well as the pneumatic controller itself are removed. The incoming pneumatic line and the outgoing pneumatic line to the valve can be disposed of. A conduit and wire are then installed from a battery source to the valve for operation. The control wires are installed from the first controller 26 to the level controller 24 for operations. Advantageously, the installation process dispenses of any need to break into the separator.

In some embodiments, the electrically actuated controls of the separator system 100 are solar powered. The use of solar energy to power the separator system 100 advantageously reduces (or eliminates) carbon dioxide emissions. In this embodiment, the separator system 100 may include various devices or systems useful for capturing and storing solar energy. For example, in one embodiment, the solar power may be supplied by one or more solar panels operatively connected to the separator system 100. The solar panels may utilize photovoltaics. In this aspect, when the sun shines onto the solar panel, energy from the sunlight is absorbed by the photovoltaic cells in the panel. This energy creates electrical charges that move in response to an internal electrical field in the cell, causing electricity to flow and power the electrical components of the separatory system 100.

In another embodiment, the separator system 100 may include one or more concentrating solar-thermal power (CSP) systems. CSP systems use mirrors to reflect and concentrate sunlight onto receivers that collect solar energy and convert it to heat, which can then be used to produce electricity or stored for later use. For example, in one embodiment, solar power may be captured by utilizing mirrors or lenses to concentrate a large area of sunlight onto a receiver. Mirrors of different shapes may be used, such as rectangular, curved (U-shaped), and a combination of smaller flat mirrors formed into a dish-shaped mirror. Such mirrors may be placed as tilted toward the sun and used to collect the sun's energy by focusing sunlight on tubes (or receivers) that run the length or any other dimension of the mirrors. The reflected sunlight may be used to power the electrical components of the separator system 100.

Solar concentrating technologies may include, for example, parabolic troughs, dishes, linear Fresnel reflectors, or Solar Power Towers. In one embodiment, a parabolic trough or a parabolic dish may be used as a solar collector for the separator system 100. In parabolic trough systems, receiver tubes are positioned along the focal line of each parabolic mirror. A parabolic solar thermal collector is straight in one dimension and curved in the other dimensions. The curvature may be a parabola in the other two dimensions and lined with a polished metal mirror. In another embodiment, a linear Fresnel reflector system may be used as a solar collector. In linear Fresnel reflector systems, one receiver tube may be positioned above several mirrors to allow the mirrors to have mobility in order to track the direction of the sun as it moves during the day. The sunlight which enters the mirror parallel to its plane of symmetry is focused along the focal line.

The methods and systems described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the systems and methods in addition to those shown and described herein will become apparent to those skilled in the art from the foregoing description. Such modifications are also intended to fall within the scope of the disclosure. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A separator, comprising:
a programmable controller,
a level controller for maintaining a level of a process fluid in the separator, the level controller operatively connected to the programmable controller and the level controller comprising an electric switch for sending an electrical signal to the programmable controller when the level of the process fluid in the separator is at a predetermined high set point,
a valve operatively connected to the programmable controller and the level controller, wherein the valve is an electrically actuated valve having an open position that allows the process fluid to flow through the valve and a closed position that prevents the process fluid from flowing through the valve, and
wherein the programmable controller is configured to receive the signal from the level controller when the level of the process fluid in the separator is at the predetermined high set point and, in response, communicate the signal to the electrically actuated valve such that the valve moves to the open position.

2. The separator of claim 1, wherein the programmable controller is a programmable logic controller.

3. The separator claim 1, wherein the electrically actuated valve comprises a valve body size of about 1 inch to about 2 inches.

4. The separator of claim 1, further comprising a device for capturing and storing solar energy.

5. The separator of claim 1, wherein the programmable controller comprises a relay circuit, wherein the relay circuit is operatively connected to the level controller and the electrically actuated valve.

6. The separator of claim 1, wherein the process fluid is oil, gas, or water.

7. The separator of claim 1, further comprising a second valve operatively connected to the programmable controller and to a second level controller, the second level controller comprising an electric switch for sending an electrical signal to the programmable controller when the level of a second process fluid in the separator is at a predetermined high set point.

8. The separator of claim 1, further comprising a sales valve configured for controlling the flow of gas out to a sales line, wherein the sales valve is an electrically actuated valve.

9. The separator of claim 1, wherein the level controller is intrinsically safe.

10. The separator of claim 1, wherein the level controller is explosion proof.

11. A separator, comprising:
a programmable controller,
a level controller for maintaining a level of a process fluid in the separator, the level controller operatively connected to the programmable controller and the level controller comprising a fiber optic sensor system for sending an electrical signal to the programmable controller when the level of the process fluid in the separator is at a predetermined high set point, wherein the fiber optic sensor system comprises:
an optical fiber configured to transmit and receive an optical signal between an emitter and a sensor positioned on the level controller, wherein the sensor is configured to reflect at least a portion of the optical signal through the optical fiber when the level of the process fluid reaches the predetermined high set point,
an amplifier in optical communication with the optical fiber, wherein the amplifier is configured to amplify the reflected optical signal, and
a receiver operatively connected to the amplifier, wherein the receiver is configured to convert the amplified optical signal into an electrical signal,
a valve operatively connected to the programmable controller and the level controller, wherein the valve is an electrically actuated valve having an open position that allows the process fluid to flow through the valve and a closed position that prevents the process fluid from flowing through the valve, and
wherein the programmable controller is configured to receive the electrical signal from the receiver when the level of the process fluid in the separator is at the predetermined high set point and, in response, communicate the signal to the electrically actuated valve such that the valve moves to the open position.

12. The separator of claim 11, wherein the emitter comprises a laser diode or a light-emitting diode (LED).

13. The separator of claim 11, wherein the sensor is in direct contact with the level controller.

14. The separator of claim 11, wherein the programmable controller is a programmable logic controller.

15. The separator of claim 11, wherein the programmable controller is further configured to receive an electrical signal from the receiver when the level of the process fluid in the separator is below the predetermined high set point and, in response, communicate the signal to the electrically actuated valve such that the valve moves to the closed position.

16. The separator of claim 11, wherein the level controller is intrinsically safe and explosion proof.
